(19) United States
(12) Patent Application Publication
(10) Pub. No.: US 2009/0268780 A1
(43) Pub. Date: Oct. 29, 2009

(54) TEMPERATURE MEASUREMENT DEVICE HAVING SEPARABLE THERMAL COUPLING WIRES

(75) Inventor: TAY-JIAN LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/411,348

(22) Filed: Mar. 25, 2009

(30) Foreign Application Priority Data
Apr. 28, 2008 (CN) 200810066868.6

(51) Int. Cl. G01K 7/02

(52) U.S. Cl. 374/179; 374/E07.004

(57) ABSTRACT

A temperature measurement device includes a first member forming a first claw at an end thereof and a second member forming a second claw at an end thereof. The second claw faces the first claw, and can move towards and away from the first claw. A spring is provided between the first member and the second member for generating force to move the second claw towards the first claw. A pair of thermal coupling wires are fixed on the first and second claws, respectively. Thus an object needed to be measured can be arranged between the pair of thermal coupling wires and snugly engage the thermal coupling wires by the elastic force of the deformed spring.

### CROSS-REFERENCE TO RELATED APPLICATION

This application is related to a co-pending application entitled “TEMPERATURE MEASUREMENT DEVICE”, filed ______ (Atty. Docket No. US19567), assigned to the same assignee of this application and filed on the same date. The disclosure of the co-pending application is wholly incorporated herein by reference.

### BACKGROUND

1. Technical Field

The disclosure generally relates to temperature measurement devices, and more particularly to a temperature measurement device which can lower an interface thermal resistance between the temperature measurement device and an object to be measured.

2. Description of Related Art

Thermocouples are widely used as temperature measurement devices for measuring the temperature of an object. The thermocouple includes two different metals, and produces a small unique voltage for a given temperature. The voltage generated by the thermocouple is measured and interpreted by a thermocouple thermometer. During operation, the different metals of the thermocouple attach to the object to be measured, and soon a heat balance is reached between the different metals and the object, and the different metals produce a voltage corresponding to detected temperature. However, the contact surfaces between the different metals of the thermocouple and the object can be rough and loose, such that the interface thermal resistance between the thermocouple and the object is relatively high, resulting in a response speed of the temperature measurement of the object to be slow. Even after time, the temperature of the different metals of the thermocouple may not reach the same temperature as the object. Temperature measured by the thermocouple is not accurate.

For the foregoing reasons, there is a need in the art for a temperature measurement device which can overcome the limitations described.

### BRIEF DESCRIPTION OF THE DRAWINGS

FIG. 1 is a side view of a temperature measurement device according to a first embodiment.

FIG. 2 is an isometric view of one detection element of a detection member of the temperature measurement device of FIG. 1.

FIG. 3 is an isometric view of a thermal coupling wire of the detection element of FIG. 2.

FIG. 4 is an isometric view of a detection element of a temperature measurement device according to a second embodiment.

FIG. 5 is an isometric view of a thermal coupling wire of the detection element of FIG. 4.

FIG. 6 is a cross section of a temperature measurement device according to a third embodiment.

FIG. 7 shows the temperature measurement device of FIG. 6 being in use.

FIG. 8 is a cross section of a temperature measurement device according to a fourth embodiment.

FIG. 9 is an isometric view of a detection element of the temperature measurement device of FIG. 8.

### DETAILED DESCRIPTION

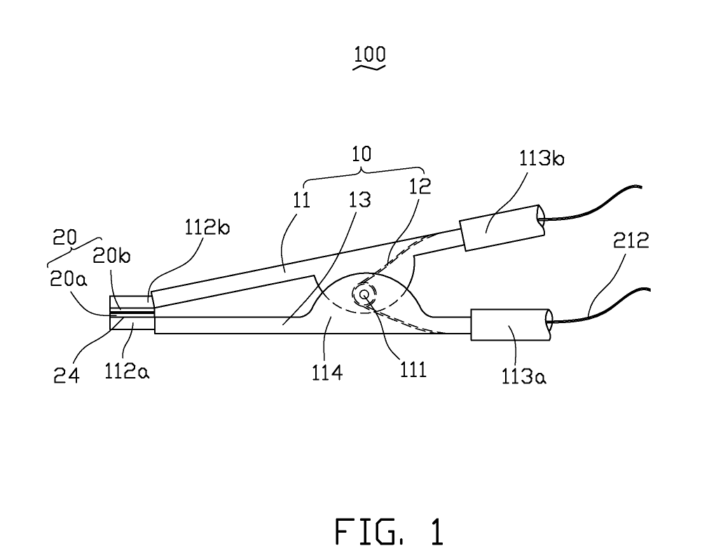

Referring to FIG. 1, a temperature measurement device 100 for an object according to a first embodiment includes a clamping member 10 and a detection member 20.

The clamping member 10 includes a first grip 11, a second grip 13, and a spring 12 provided between the first grip 11 and the second grip 13. The first grip 11 and the second grip 13 are substantially identical, and face each other. In this embodiment, the first grip 11 is arranged over the second grip 13. Each of the first grip 11 and the second grip 13 includes a claw 112b, 112a and a handle 113b, 113a formed at two opposite ends (i.e., first and second ends) thereof, respectively. Each claw 112a, 112b forms a planar inner side 24 facing the other claw 112b, 112a. A pivotal section 114 extends from a middle of each of the first and second grips 11, 13 towards the other grip 13, 11. A pin 111 is pivotally connected between the pivotal sections 114 to assemble the first grip 11 and the second grip 13 together.

The spring 12 is a torque spring providing the clamping member 10 with elastic clamping force. The spring 12 surrounds the pin 111 with two ends thereof respectively abutting inner sides of the handle 113b of the first grip 11 and the handle 113a of the second grip 13. Thus the handles 113a, 113b are spaced from each other, and the claws 112a, 112b are close to each other under the action of the elastic force of the spring 12. When pressure is exerted on the handle 113b of the first grip 11 and the handle 113a of the second grip 13, the spring 12 is deformed. The handle 113a of the second grip 13 and the handle 113b of the first grip 11 move toward to each other, and the claw 112b of the first grip 11 and the claw 112a of the second grip 13 are separated for accommodating the target object to be measured therebetween.

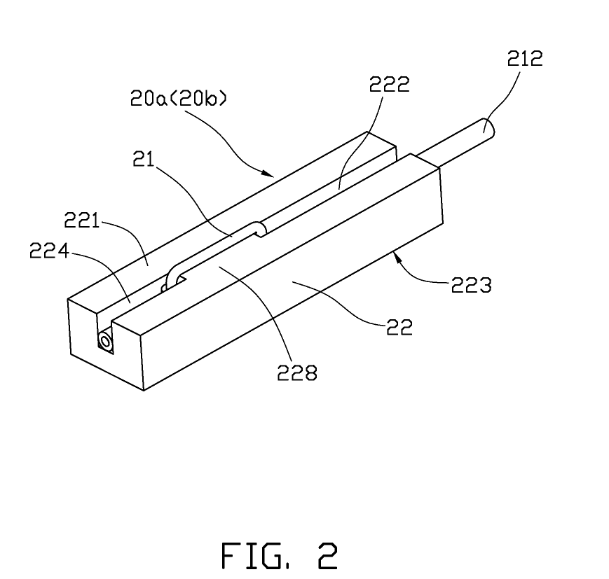

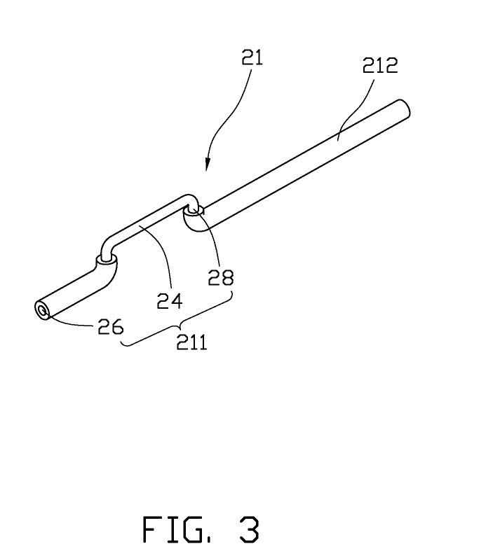

The detection member 20 includes a pair of detection elements 20a, 20b being identical to each other. Referring to FIGS. 2 and 3, each detection element 20a, 20b includes a supporting element 22 and a thermal coupling wire 21 fixed on the supporting element 22. The supporting element 22 is made of a material providing thermal and electrical insulation, such as plastic. The supporting element 22 is rectangular, and includes a flat top surface 221 and a flat bottom surface 223 parallel to the top surface 221. When assembled, the bottom surface 223 of the supporting element 22 of the detection element 20a is fixed to the inner side 24 of the claw 112a of the second grip 13 to assemble the detection element 20a on the claw 112a of the second grip 13, and the bottom surface 223 of the supporting element 22 of the detection element 20b is fixed to the inner side 24 of the claw 112b of the first grip 11 to assemble the detection element 20b on the claw 112b of the first grip 11. Thus the detection member 20 is assembled onto the clamping member 10 to form the temperature measurement device 100.

A first groove 224 is concaved from a first side of the top surface 221 of the supporting element 22, and a second groove 222 is concaved from a second side of the top surface 221 of the supporting element 22. The first groove 224 and the second groove 222 are shallower than a thickness of the supporting element 22. The first and second grooves 224, 222 are spaced from each other, with a bridge 228 formed therebetween by the top surface 221 of the supporting element 22. As viewed from a top side, the top surface 221 of the supporting element 22 is substantially H-shaped.

The thermal coupling wire 21 constitutes an insulating layer 212 covering a bare wire 211. The bare wires 211 of the two detection elements 20a, 20b are of dissimilar metals. Each bare wire 211 includes a middle portion 24, a first end portion 26 bending from a first end of the middle portion 24, and a second end portion 28 bending from a second end of the middle portion 24. The insulating layer 212 only surrounds the first and second end portions 26, 28 of the bare wire 211, and the middle portion 24 of the bare wire 211 is exposed to form a contact portion of the thermal coupling wire 21. The contact portion of each thermal coupling wire 21 has a length substantially equal to that of the bridge 228 of the supporting element 22, and is located on the bridge 228. The first end portion 26 of the thermal coupling wire 21 is received in the first groove 224, and the second end portion 28 of the thermal coupling wire 21 is received in the second groove 222 of the supporting element 22.

During operation of the temperature measurement device 100, the second end portions 28 of the two thermal coupling wires 21 of the detection elements 20a, 20b extend along the handle 113a of the second grip 13 and the handle 113b of the first grip 11 of the clamping member 10, respectively, to electrically connect to a thermocouple thermometer (not shown). Pressure is exerted on the handles 113a, 113b, and thus the two detection elements 20a, 20b on the claws 112a, 112b are separated. The target object can thus be gripped between the detection elements 20a, 20b by the elastic force of the spring 12 separating the handles 113b, 113a of the first and second grips 11, 13 with the claws 112b, 112a of the first and second grips 11, 13 of the clamping member 10 impelled toward each other. The object thus snugly meets the contact portions of the two thermal coupling wires 21 of the detection elements 20a, 20b of the detection member 20. Accordingly, heat resistance between the object and the thermal coupling wires 21 is significantly decreased, and the thermal coupling wires 21 are more effectively responsive to temperature. Measurement of temperature by the temperature measurement device 100 is thus more accurate.

After measurement is accomplished, pressure is exerted on the handles 113a, 113b of the clamping member 10 to separate the detection elements 20a, 20b which are fixed on the claws 112a, 112b, allowing easy removal of or departure of the temperature measurement device 100 from the object. The time for measurement of a single object is shortened, and the precision of the temperature measurement device 100 is improved.

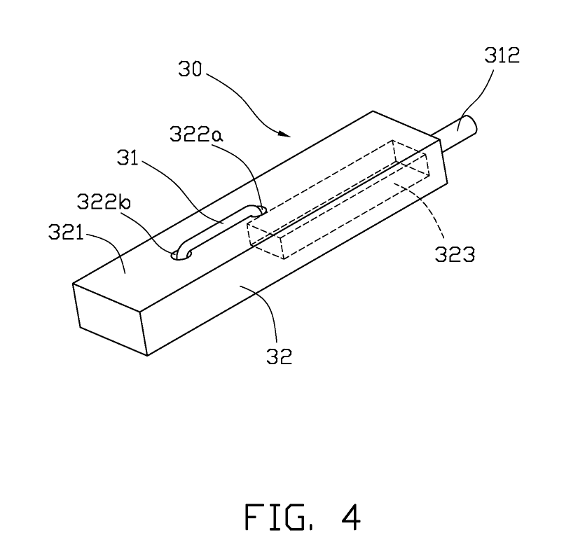

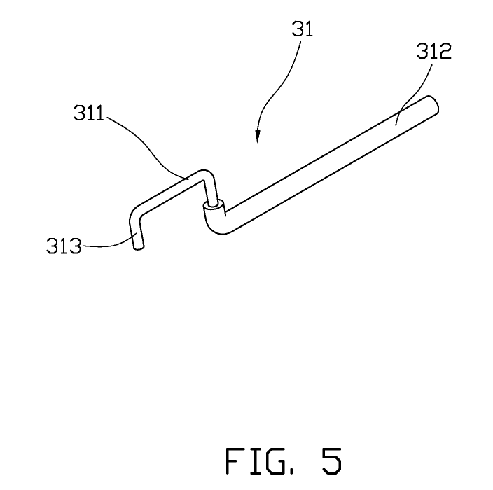

FIGS. 4 and 5 show a second embodiment of a detection element 30 of the temperature measurement device. Similar to the first embodiment, to form the temperature measurement device, two detection elements 30 are provided and are respectively fixed on the inner sides 24 of the claws 112a, 112b of the clamping member 10, respectively. Each detection element 30 includes a supporting element 32 and a thermal coupling wire 31. The supporting element 32 is rectangular, and defines a pair of mounting holes 322a, 322b therein. The thermal coupling wire 31 has a middle portion 311 of a bare wire, a left bending portion 313, and a right bending portion 312 constituted by a bare wire covered partially by an insulating layer. The middle portion 311 forms the contact portion of the thermal coupling wire 31, and is located on a top surface 321 of the supporting element 32. The left bending portion 313 is inserted into the mounting hole 322b, and the right bending portion 312 is inserted into the other mounting hole 322a. A slot 323 is concaved from a bottom side of the supporting element 32 and communicates with the mounting hole 322a. A distal end of the right bending portion 312 of the thermal coupling wire 31 extends through the supporting element 32 along the slot 323 to connect with the thermocouple thermometer.

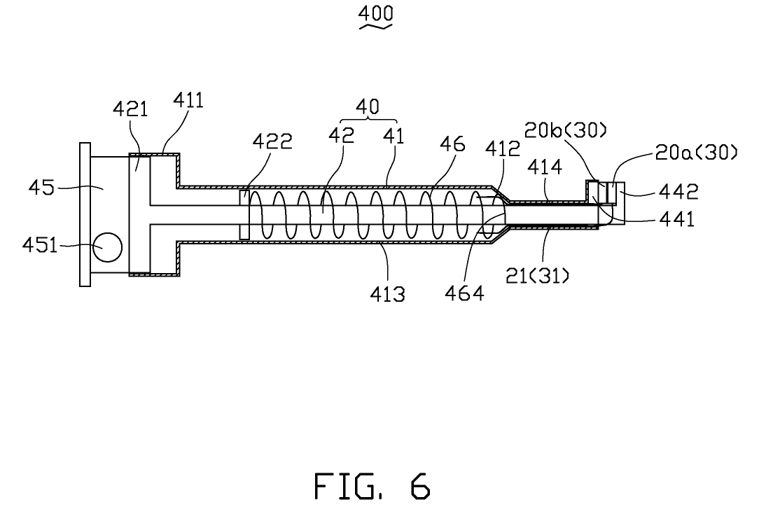

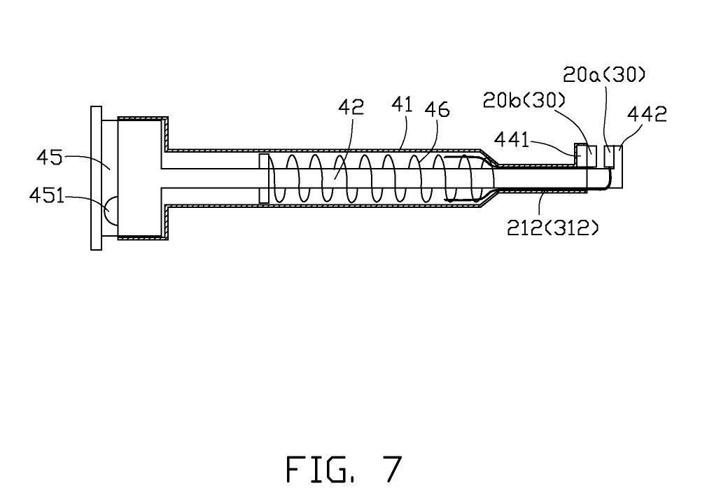

FIGS. 6-7 show a temperature measurement device 400 according to a third embodiment, differing from the previous embodiments only in that the clamping member 40 includes a hollow tube 41 and a solid shaft 42 received therein. The tube 41 includes a middle portion 413, a first end portion 411 having an inner diameter larger than that of the middle portion 413, and a second end portion 414 having an inner diameter smaller than that of the middle portion 413. A first claw 441 extends upwardly from a distal end of the second end portion 414 of the tube 41. The first claw 441 is perpendicular to a central axis of the tube 41, and can be integrally formed with the tube 41 by bending the distal end of the second end portion 414 of the tube 41.

In this embodiment, the diameter of the shaft 42 is substantially the same as the inner diameter of the second end portion 414, and a length of the shaft 42 is substantially the same as that of the tube 41. Alternatively, the diameter of the shaft 42 can be a little smaller than the inner diameter of the second end portion 414. A second claw 442 extends upwardly from an end of the shaft 42 corresponding to the first claw 441 of the tube 41. The first claw 441 and the second claw 442 are parallel, with the second claw 442 located at a lateral side of and linearly moveable relative to the first claw 441. A pair of detection elements 20b, 20a are respectively fixed on the first claw 441 and the second claw 442, and face each other. Alternatively, a pair of detection elements 30 can also be fixed on the first and second claws 441, 442 to form a temperature measurement device.

A coil spring 46 is received in the middle portion 413 of the tube 41 and surrounds the shaft 42. A diameter of the coil spring 46 exceeds the inner diameter of the second end portion 414, and not larger than the inner diameter of the middle portion 413 of the tube 41. A first end 422 of the coil spring 46 is fixed onto the shaft 42. As shown in FIG. 6, when the temperature measurement device is not in use, i.e., the claws 441, 442 are closed to each other without the object therebetween. The coil spring 46 is free with a second end 464 thereof abutting a joint part 412 of the middle portion 413 and the second end portion 414 of the tube 41. A flat plate 421 is formed at a first end of the shaft 42 with a diameter substantially equal to the inner diameter of the first end portion 411 of the tube 41. The flat plate 421 is slidably received in the first end portion 411. The flat plate 421 is perpendicular to the shaft 42. A handling portion 45 extends outwardly from the flat plate 421 of the shaft 42. An opening 451 is defined in the handling portion 45 for extension of the thermal coupling wires 21 (31) of the detection elements 20a, 20b (30) of the temperature measurement device 400 therethrough to connect to the thermocouple thermometer.

During operation, the handling portion 45 is pressed to move outward, and thus the shaft 42 moves outwardly along a central axis thereof to compress the coil spring 46. The second claw 442 of the shaft 42 moves away from the first claw 441 by the movement of the shaft 42 (as shown in FIG. 7). Thus the object can be put between the detection elements 20a, 20b (30). Then pressure on the handling portion 45 of the shaft 42 is then removed, such that the first claw 441 and the second claw 442 with the detection elements 20a, 20b (30) can tightly engage the object for measurement by the elastic force of the compressed coil spring 46.

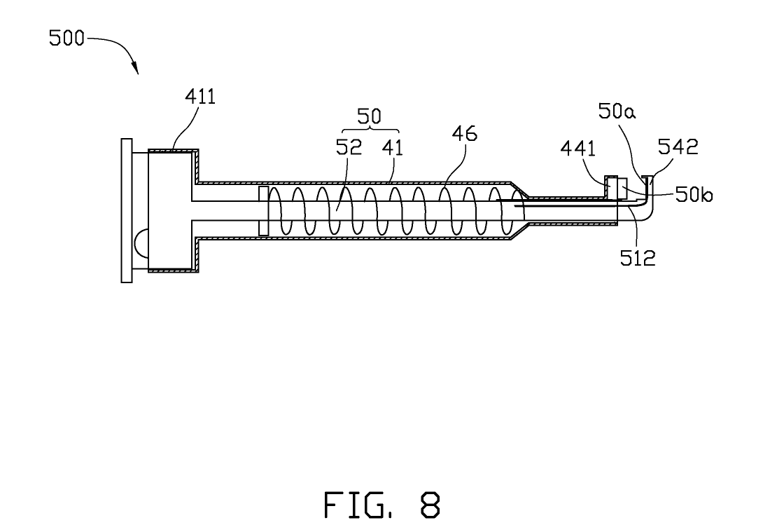

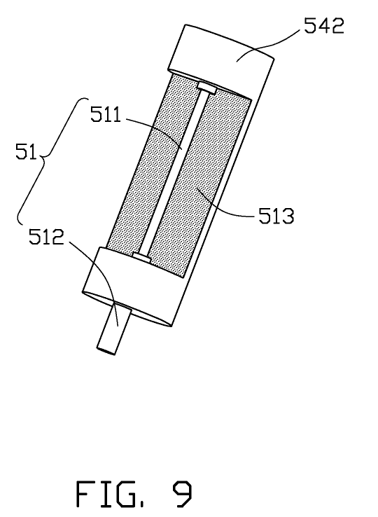

FIGS. 8 and 9 show a fourth embodiment of a temperature measurement device 500 which includes a clamping member 50, a first detection element 50b, and a second detection element 50a. The clamping member 50 includes a tube 41, a shaft 52 extending through the tube 41, and a spring 46 fixed on and surrounding the shaft 52. The tube 41 is substantially the same as the third embodiment, which forms a first claw 441 at an end thereof and has the first detection element 50b fixed on the first claw 441. Accordingly, the first detection element 50b can be identical to the detection element 20a/20b/30.

The temperature measurement device 500 differs from the temperature measurement device 400 of the previous embodiment in the shaft 52 of the clamping member 50. In this embodiment, the shaft 52 is hollow. An end of the hollow shaft 52 is bent upwardly with a side thereof adjacent to the first claw 441 being cut to form a second claw 542. The second detection element 50a is fixed onto the cut side of the second claw 542 directly, and faces the first detection element 50b. The second detection element 50a is a thermal coupling wire. A bare portion 511 of the thermal coupling wire without insulating layer is located on the cut side of the second claw 542, and forms a contact portion of the second detection element 50a. An insulating layer 513 is coated on the cut side of the second claw 542 insulating the contact portion of the second detection element 50a from the second claw 542. Thus the supporting element 22 (32) of the detection element 20a, 20b (30) is no necessary for the second detection element 50a, reducing cost and size of the temperature measurement device 500. An end 512 of the thermal coupling wire is covered with an insulating layer and extends through the hollow shaft 52 to connect to the thermocouple thermometer. When the shaft 52 is moved outward, the second claw 542 separates from the first claw 441 to accommodate the object therebetween.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A temperature measurement device for measuring the temperature of an object, comprising:
a clamping member having a pair of claws and a spring, the spring providing force to close the pair of claws and thereby enabling the claws to clamp the object therebetween; and
a pair of thermal coupling wires fixed on the pair of claws of the clamping member, respectively, for snugly engaging the object during measurement by action of the spring.

2. The temperature measurement device of claim 1, wherein the clamping member comprises a pair of grips facing each other, and a pin interconnecting middle portions of the pair of grips, the spring surrounding the pin and having two ends abutting inner sides of first ends of the pair of grips, respectively, other ends of the pair of grips forming the pair of claws.

3. The temperature measurement device of claim 2, wherein a supporting element of a material providing thermal and electrical insulation is fixed on each of the pair of claws, and each of the thermal coupling wires is fixed on one supporting element.

4. The temperature measurement device of claim 3, wherein each thermal coupling wire comprises a bare wire with ends thereof having an insulating layer thereon, a portion of the thermal coupling wire which is located between the ends and does not have the insulating layer thereon being fixed on an outer surface of the supporting element, and the ends of the thermal coupling wire with the insulating layer thereon being received in the supporting element.

5. The temperature measurement device of claim 4, wherein a pair of spaced grooves are depressed from the outer surface of the supporting element, and a bridge is formed between the grooves by the outer surface of the supporting element, the portion of the thermal coupling wire without the insulating layer thereon being disposed on the bridge, and the ends of the thermal coupling wire with the insulating layer thereon being received in the grooves, respectively.

6. The temperature measurement device of claim 4, wherein a pair of spaced mounting holes are defined in the supporting element, the portion of the thermal coupling wire without the insulating layer thereon being located between the mounting holes, and the ends of the thermal coupling wire with the insulating layer thereon being inserted into the mounting holes, respectively.

7. The temperature measurement device of claim 1, wherein the clamping member comprises a hollow tube and a shaft movably received in the tube, the pair of claws being formed on distal ends of the tube and the shaft respectively and perpendicularly to an axis of the tube, the spring having a first end fixed on the shaft away from the distal end of the tube and a second end abutting the tube near the distal end thereof, the spring being compressed and the claw of the shaft moving away from the claw of the tube when the shaft moves towards the distal end thereof along the axis.

8. The temperature measurement device of claim 7, wherein a pair of thermal and electrical insulating supporting elements are fixed on the claw of the tube and the claw of the shaft, respectively, each of the thermal coupling wires is fixed on one supporting element.

9. The temperature measurement device of claim 7, wherein the shaft is hollow, and the distal end of the shaft bends perpendicular with a part near the claw of the tube being cut to form the claw of the shaft, the thermal coupling wire on the claw of the shaft being fixed on the claw of the shaft directly.

10. The temperature measurement device of claim 7, wherein the tube includes a middle portion, a first end portion having an inner diameter lager than that of the middle portion, and a second end portion having an inner diameter smaller than that of middle portion, the second end of the spring abutting a joint part of the second end portion and the middle portion of the tube, and the claw of the tube being formed at a distal end of the second end portion.

11. A temperature measurement device, comprising:
a first member forming a first claw at an end thereof;
a second member forming a second claw at an end thereof facing the first claw, the second claw moveable toward and away from the first claw;
a spring provided between the first member and the second member and generating force to move the second claw toward the first claw;
a first thermal coupling wire fixedly on the first claw of the first member; and
a second thermal coupling wire fixedly on the second claw of the second member.

12. The temperature measurement device of claim 11, wherein the first member is a hollow tube, and the second member is a shaft received in the tube, the first and second claws are perpendicular to an axis of the tube, and the shaft moves along the axis of the tube to cause the second claw to move towards or away from the first claw.

13. The temperature measurement device of claim 11, wherein the first member and the second member are two grips facing each other with middle portions thereof connected by a pin, the spring surrounding the shaft with two ends thereof abutting inner sides of other ends of the grips, respectively.

14. The temperature measurement device of claim 11, wherein a first supporting element is fixed on the first claw directly, the first thermal coupling wire is fixed on the first supporting element, and a second supporting element is fixed on the second claw directly, the second thermal coupling wire is fixed on the second supporting element, the first and second supporting elements being thermally and electrically insulating.
